(19) United States
(12) Patent Application Publication
(10) Pub. No.: US 2007/0071184 A1
(43) Pub. Date: Mar. 29, 2007

(54) Automated Voice Activated Telephone Reminder System

(76) Inventors: Jeffrey C. Clift, Melbourne, FL (US); Gavin Ridge, Vero Beach, FL (US)

Correspondence Address: Jeffrey Clift, 571 Wethersfield Place, Melbourne, FL, 32940, US

(21) Appl. No.: 11/162,926

(22) Filed: Sep. 28, 2005

(51) Int. Cl. H04M 1/64; H04Q 7/20

(52) U.S. Cl. 379/88.01; 455/461

(57) ABSTRACT

A method and system for automatically providing remote reminders via a telephone or similar device capable of delivering voice quality communication at a specified time and date. Reminders are scheduled by telephone or other voice interactive means whereby a requester calls a specific number and schedules a reminder message to be sent to a specific telephone number at a specific time and date or multiple times if it is to be a daily, weekly or other regularly scheduled event. An operator or automated voice interactive system would allow the caller to specify the time(s) and date(s) for the call to be made as well as record the message that is to be delivered to the recipient's telephonic device at the specified time and date. The recipient's telephone number would be supplied as well and could be any valid telephone number worldwide, whether wireless or wireline.

### BACKGROUND OF THE INVENTION

The invention relates generally to a system and method for reminder notifications over a telecommunications network and, more particularly, the invention relates to automatic notification via telephone based on reminders that are scheduled by telephone voice interaction.

### DESCRIPTION OF THE RELATED ART

Computers, cell phones and PDAs have become commonplace devices as users have become dependent on technology to keep them connected and up to date regarding the world around them. Although there is increasing penetration of technology throughout all ages and demographics, there still remains a large population that is not comfortable, capable or lacks the financial means to enjoy all of these conveniences. Very few people do not have access to a telephone, whether a traditional wireline phone, cellular phone or IP based service, and all of these can be accessed by one another seamlessly.

There are various ways for people to be reminded of important events. Simple alarm clocks, e-mail messages, SMS messages, pagers and other electronic devices all provide simple means of alerting someone when a scheduled time has arrived, but these all require the person to be available to the device that was programmed in order to deliver the reminder.

In this day and age, no one is ever too far from a phone, young and old alike. It is also true that many people are busier than ever and are scheduling more things into their available time. As many demands on one's time build up, the ability to schedule them all and coordinate with others is increasingly more difficult, especially when there are so many ways to communicate. In addition, it is common practice for people to forward one or more contact numbers to a telephone number that will be accessible by the recipient. In many case, a home or office phone is forwarded to a cell phone, which is likely to be in the person's possession. In this way, people go to great lengths to ensure that they are reachable via phone, regardless of the multiple phones that might be used to contact them. As such, it is because of this accessibility, that there exists a need to utilize this convenience in delivering reminders that have been scheduled using the same ubiquitous network.

What is needed is a system and method to schedule a reminder by using any telephony or similar voice activated device anywhere in the world that will notify someone about that scheduled event or appointment using that same or any other telephony device at the scheduled time. As an example, this would be particularly useful for reminding an elderly person to take medication at a prescribed time, whether it is once, daily or at any scheduled interval. This would also be useful for someone to schedule a reminder for their spouse or acquaintance to pick up their children at a specified time and place.

U.S. Pat. Application No. US20010019603A1 discloses a reminder system incorporating a call server that delivers a recorded message to a user at a predetermined time, however the system does not address the means by which the appointment is scheduled such as an IVR system, does not allow for repetitive reminders, does not address retries in the even the call cannot be completed, makes no provision for canceling an appointment and does not address various service models that could be employed by such a system.

U.S. Pat. No. 6,678,613B2 discloses computation of travel time and alerts a user at an appropriate departure time based on the location of their current position and their appointment destination. No method to establish the appointment is given and the system is more concerned with navigation and travel time than with appointment scheduling and reminding.

US Patent Application Nos. US20030224762A1, US200401 56486A1 and US20050055648A1 all describe computer based appointment systems that remind users of appointments via various means, but all are based on computer based events and none describe a means of establishing or canceling the appointment using telephones or any type of voice interaction.

### SUMMARY OF THE INVENTION

A method and system for providing automatic reminders to a user of a telecommunications device based on scheduled reminders programmed using voice commands over any voice enabled telecommunications device.

In one embodiment of the system, an IVR system responds to calls place to a dedicated number, toll-free or otherwise (this could be a 1-900 type of service). The IVR prompts the caller to provide information regarding the date, time and repetition (if this is to be a daily, weekly or similar type of reminder) as well as the number to be called for delivery of the reminder. Once the reminder has all of the information required to place the call, the caller is then asked to record a brief message that would be played when the phone call reminder was delivered. This allows the reminder message to be language independent and in the scheduler's own voice. The information is captured in an automated system that would place an outbound telephone call to the destination number at the specified time and deliver the prerecorded message. In the event that the call does not complete, the system will automatically requeue the message to be retried at a predetermined interval until the call is completed or the reminder is cancelled. The system must provide a means for someone to call and cancel a previously scheduled reminder.

In another embodiment, the IVR system could be replaced by a live operator who enters the information into the scheduling system manually. The reminder call would be placed automatically by the system at the predetermined time.

The market for this type of system could be a traditional telecommunications provider (telco), cellular provider or independent service, but the concept remains the same. In all cases, the user would interact with the system in the same manner regardless of who provides the service.

### BRIEF DESCRIPTION OF THE DRAWINGS

FIG. 1 is a block diagram of a system for providing automatic reminders. In the diagram, the reminder scheduler calls the system via a dedicated number and provides the information regarding the reminder so that it can be scheduled in the reminder system database. At the specified time, the reminder system retrieves the message from the database and calls the destination number to deliver the previously recorded message.

### DETAILED DESCRIPTION

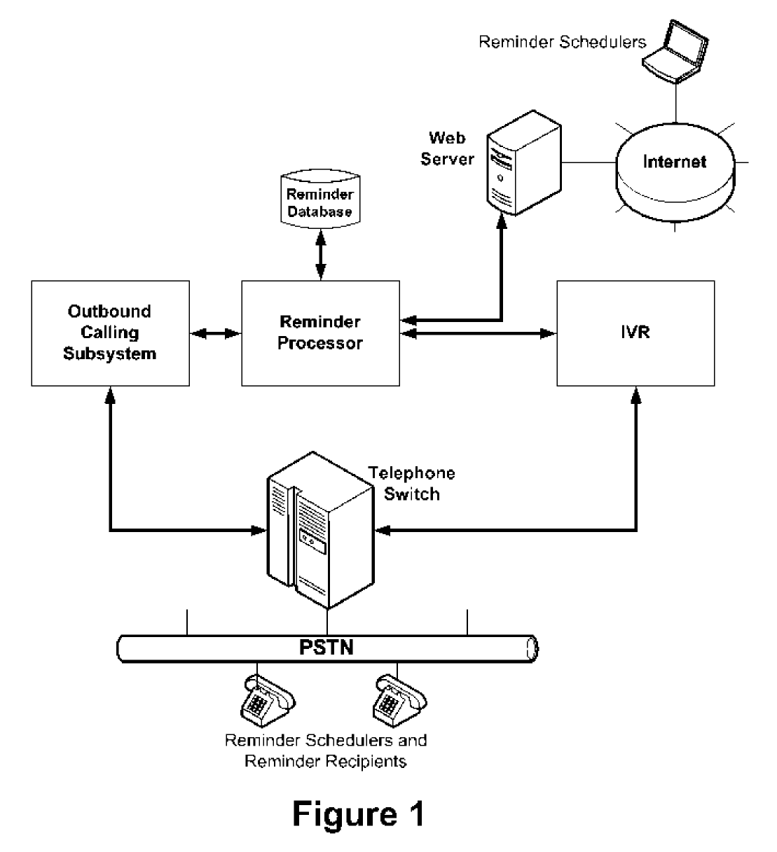

With reference to FIG. 1, a system for scheduling reminders to be delivered via ordinary telephone service consists of a means for receiving the required information, typically an Interactive Voice Response (IVR) system, a processor capable of storing and retrieving the information, including the recorded reminder message and a means of calling the destination telephone to deliver the message at the prescribed time and date or on multiple occasions.

In the described system, the caller initiates a conversation with either an IVR system or a live operator who collects the required information necessary to schedule the reminder. The elements of required information consist of the items below, at a minimum.
(1) Time to call the destination number (and optional time zone if necessary)
(2) Date to call the destination number
(3) Number to call
(4) Message to be delivered (a recorded voice message)

In addition, optional information, such as that listed below can also be collected if the system is intended to offer expanded functionality.
(1) Number of times to schedule the reminder
(2) Interval between reminder calls in minutes, hours, days, weeks, etc. (if the number of times is greater than 1)
(3) Number of times to try (in the event that call cannot be completed)
(4) Interval between retries (if the number of times to try is greater than 1)
(5) A user identifier or password to be used to cancel the reminder

The recorded message can be either an analog or digital recording of the caller's message and should be limited to a predefined duration, for example, no more than a 30 second message, although this may vary with the implementation.

The IVR or operator interfaces with the reminder system to provide the required information so that the reminder system can save it in the reminder database. The reminder system has a built in scheduler that compares the current time with the stored reminders. When a reminder time arrives, the reminder system retrieves the reminder message from the database, calls the destination number and if the call is answered, delivers the message to the recipient. Optionally, the reminder system can prompt the recipient to acknowledge the message by either a verbal or touch tone response.

In the event that the destination number is busy or does not answer, the system will automatically schedule a retry based on the information in the reminder record.

Once the reminder has been delivered to the recipient, the reminder is marked as delivered and is removed from the scheduler. If this is a periodic reminder, then other occurrences would not be removed unless the reminder is cancelled.

The system would also provide via the IVR or live operator, a mechanism to cancel a previously scheduled reminder. This requires the caller to be able to identify the reminder based on any or all of the information provided when the reminder was scheduled. At a minimum, this would require the destination telephone number.

What is claimed is:

1. A method for providing telephone reminders comprising the steps of:
providing a means for a person to call and schedule a reminder using any manner of telephony device;
where the caller would communicate with an Interactive Voice Response (IVR) system in any supported language and specify sufficient information to define a reminder. This information would include at a minimum, the number to call and the time and date to call;
where there would be provision to record a message by the scheduler that is to be delivered via the reminder call;
where a call to the specified number would be placed at the scheduled time in order to deliver the prerecorded message; and
where the system would continue to attempt the reminder call at predetermined intervals until the reminder is successfully delivered or until the reminder is canceled.

2. The system of claim 1 where the IVR is replaced by a live operator.

3. The system of claim 1 or 2 where the IVR is replaced by an Internet interface (web page) and the message is typed in as text or selected from a list of predefined messages. This same interface would provide a means of canceling a previously scheduled appointment.

4. The system of claim 1 or 2 where a means would be available to use the same system to cancel a previously scheduled reminder. The reminder to be cancelled would be identified by using some portion of or all of the information collected at the time of scheduling.

5. The system of claim 1 or 2 where additional information is collected that allows periodic reminders to be sent. This information would include, at a minimum, the number of times to schedule the reminder and the interval between reminders. The interval could be any time interval including minutes, hours, days, weeks or months.

6. The system of claim 1 or 2 where the system is used to provide information on a general basis, such as theater events, scheduled car maintenance or birthday reminders.

7. The system of claim 1 or 2 where the subscription method is a transaction fee paid via a toll call, such as a 1-900 service number.

8. The system of claim 1 or 2 where the subscription method is a credit card, prepaid card or debit card transaction.

9. The system of claim 1 or 2 where the subscription method is a monthly (or alternate periodic) service billed directly or bundled by a service provider.
